(19) United States
(12) Patent Application Publication
(10) Pub. No.: US 2024/0321245 A1
(43) Pub. Date: Sep. 26, 2024

(54) METHOD FOR CONTROLLING SOUND, SOUND CONTROLLING DEVICE AND ELECTRONIC KEYBOARD INSTRUMENT

(71) Applicant: YAMAHA CORPORATION, Hamamatsu-shi (JP)

(72) Inventors: Haruki OHKAWA, Hamamatsu-shi (JP); Shinji SUMINO, Hamamatsu-shi (JP); Tomoya SASAKI, Hamamatsu-shi (JP)

(21) Appl. No.: 18/735,549

(22) Filed: Jun. 6, 2024

Related U.S. Application Data
(63) Continuation of application No. PCT/JP2022/040593, filed on Oct. 31, 2022.

(30) Foreign Application Priority Data
Dec. 15, 2021 (JP) 2021-203269

(51) Int. Cl. G10H 1/00; G10H 1/34

(52) U.S. Cl. CPC G10H 1/0025; G10H 1/344

(57) ABSTRACT

A method for controlling sound according to an embodiment includes: acquiring key position data corresponding to a keypress amount; inputting operation data obtained by the key position data and an acquisition timing of the key position data to a learned model that has learned a corresponding relationship between operation data configured to be used as learning data related to a time series of a keypress amount and action data configured to be used as learning data related to an action of an action mechanism on a sounding body accompanied with a keypress; and outputting sound generation instruction data configured to generate a sound signal in a signal generation unit based on action data output from the learned model.

### CROSS REFERENCE TO RELATED APPLICATIONS

This application is a Continuation of International Patent Application No. PCT/JP2022/040593, filed on Oct. 31, 2022, which claims the benefit of priority to Japanese Patent Application No. 2021-203269, filed on Dec. 15, 2021, the entire contents of which are incorporated herein by reference.

### FIELD

The present disclosure relates to a technology for controlling sound generation.

### BACKGROUND

An acoustic piano generates a piano sound by striking a string with a hammer linked to a key in response to a key operation. On the other hand, an electronic piano generates a piano sound electronically in response to a key operation. For example, an operation of a key is measured by using a sensor that detects a keypress amount, and a piano sound is generated when the key is depressed to a predetermined depth. In this way, both the electronic piano and the acoustic piano generate a sound by the key operation, but sound generation mechanisms of the electronic piano and the acoustic piano are different. Therefore, timings of sound generation may not coincide in a performance using the electronic piano and a performance using the acoustic piano even when a player performs the same performance. An electronic piano may have a structure that mimics a hammer of the acoustic piano in order to improve the touch feeling when playing. In this way, attempts have been made to realize a sound generation timing close to a performance using the acoustic piano even in a performance using the electronic piano by using the measurement of an operation of the structure linked to a key to control the sound generation timing (for example, Japanese laid-open patent publication No. 2013-210451).

As described above, a structure that mimics a hammer may be arranged in an electronic piano. This structure is a configuration for bringing the touch feeling to the key in the performance close to the touch feeling of the acoustic piano, and is not necessarily a form similar to the hammer of the acoustic piano. In the case where the electronic piano does not have the same configuration as an action mechanism of the acoustic piano, it is difficult to realize the sound generation timing similar to the performance using the acoustic piano even if a sensor is used for the action mechanism of the electronic piano.

### SUMMARY

A method for controlling sound according to an embodiment includes: acquiring key position data corresponding to a keypress amount; inputting operation data obtained by the key position data and an acquisition timing of the key position data to a learned model that has learned a corresponding relationship between operation data configured to be used as learning data related to a time series of a keypress amount and action data configured to be used as learning data related to an action of an action mechanism on a sounding body accompanied with a keypress; and outputting sound generation instruction data configured to generate a sound signal in a signal generation unit based on action data output from the learned model.

### BRIEF DESCRIPTION OF DRAWINGS

FIG. 1 is a diagram showing a configuration of a keyboard instrument according to an embodiment.

FIG. 2 is a block diagram showing a functional configuration of a sound source unit according to an embodiment.

FIG. 3 is a diagram showing a positional relationship of a key position sensor and a key depression detection pattern according to an embodiment.

FIG. 4 is a diagram showing a model set table according to an embodiment.

FIG. 5 is a block diagram showing a functional configuration of a conversion unit according to an embodiment.

FIG. 6 is a diagram showing an example of a change in a key position corresponding to a learned model MA.

FIG. 7 is a diagram showing a model used among a learned model MA.

FIG. 8 is a diagram showing an example of teacher data used when a learned model MA (1) is generated.

FIG. 9 is a diagram showing an example of a change in a key position corresponding to a learned model MB.

FIG. 10 is a diagram showing a model used among learned models MB.

FIG. 11 is a diagram showing an example of a change in a key position corresponding to a learned model MC.

FIG. 12 is a diagram showing a model used among learned models MC.

FIG. 13 is a diagram showing an example of a change in a key position corresponding to a learned model MD.

FIG. 14 is a diagram showing a model used among learned models MD.

FIG. 15 is a diagram showing an example of a change in a key position corresponding to a learned model ME.

FIG. 16 is a diagram showing a model used among learned models ME.

FIG. 17 is a diagram showing an example of a change in a key position corresponding to a learned model MF.

FIG. 18 is a diagram showing a model used among learned models MF.

FIG. 19 is a flowchart showing a method for controlling sound generation according to an embodiment.

FIG. 20 is a diagram showing a configuration of a model generation system according to an embodiment.

FIG. 21 is a flowchart showing a method for generating teacher data according to an embodiment.

FIG. 22 is a flowchart showing a method for generating a learned model according to an embodiment.

FIG. 23 is a flowchart showing a method for registering a rule table according to an embodiment.

FIG. 24 is a diagram showing a rule table according to an embodiment.

FIG. 25 is a block diagram showing a functional configuration of a sound source unit according to an embodiment.

FIG. 26 is a diagram showing a model set table according to a modification.

### DESCRIPTION OF EMBODIMENTS

Hereinafter, an embodiment of the present disclosure will be described in detail with reference to the drawings. The following embodiments are examples, and the present disclosure is not to be construed as being limited to these embodiments.

One of the objects of the present disclosure is to make a relationship between a performance and a sound generation mode in an electronic keyboard apparatus close to a relationship between a performance and a sound generation mode in a model keyboard instrument.

### [Configuration of Keyboard Instrument]

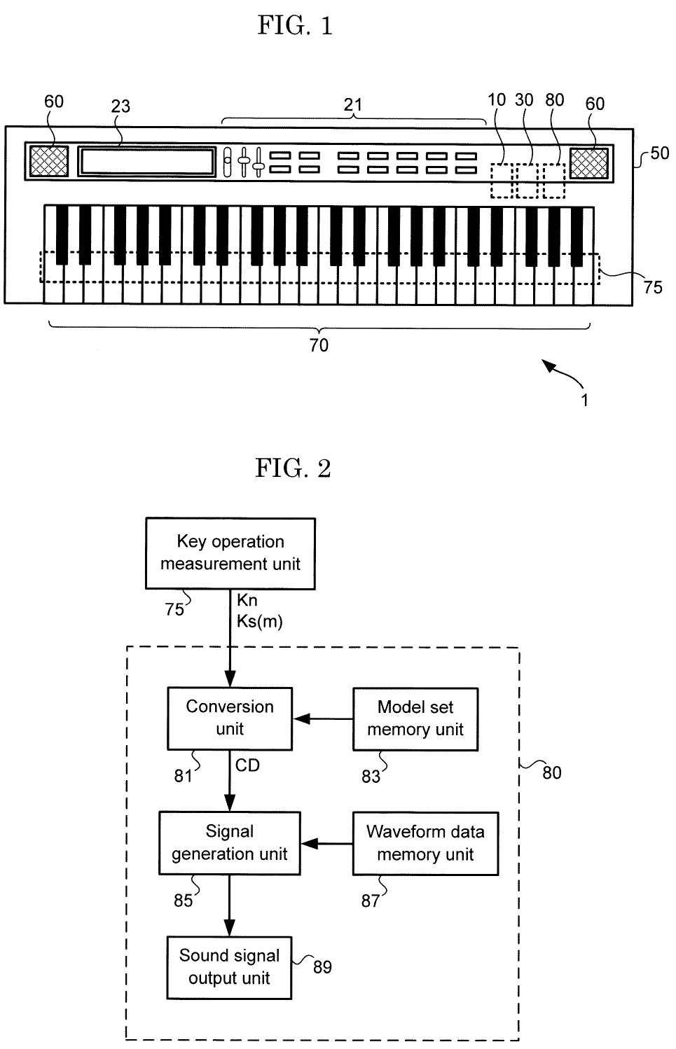

FIG. 1 is a diagram showing a configuration of a keyboard instrument according to an embodiment. For example, a keyboard instrument 1 is an electronic keyboard apparatus such as an electronic piano, and is an example of an electronic instrument having a plurality of keys 70 as a performance operating element. When a user operates the key 70, a sound is generated from a speaker 60. The type (timbre) of the generated sound is changed using an operation unit 21. In the case where the keyboard instrument 1 generates a sound using the timbre of a piano in this example, the keyboard instrument 1 can generate a sound close to an acoustic piano. In particular, the keyboard instrument 1 can realize a timing and a volume corresponding to an operation of the key 70 as a sound generation close to an acoustic piano. Next, each configuration of the keyboard instrument 1 will be described in detail.

The keyboard instrument 1 includes the plurality of keys 70 and a housing 50. The plurality of keys 70 are rotatably supported by the housing 50. The operation unit 21, a display unit 23, and the speaker 60 are arranged in the housing 50. A control unit 10, a memory unit 30, a key operation measurement unit 75, and a sound source unit 80 are arranged inside the housing 50. Each component arranged inside the housing 50 is connected via a bus.

The keyboard instrument 1 in this example includes an interface for inputting and outputting signals to and from an external device. For example, the interface is a terminal for outputting a sound signal, a cable connecting terminal for transmitting and receiving MIDI data, or the like. For example, a function such as a damper pedal may be added to the keyboard instrument 1 by connecting a pedal apparatus to the interface.

The control unit 10 includes a calculation processing circuit (processor) such as a CPU, and a memory device such as RAM and ROM. The control unit 10 implements various functions in the keyboard instrument 1 by executing a control program using the CPU. The operation unit 21 is a device such as an operation button, a touch sensor, and a slider, and outputs a signal corresponding to an input operation to the control unit 10. The display unit 23 displays an image based on a control by the control unit 10.

The memory unit 30 (memory) is a memory device such as a non-volatile memory. The memory unit 30 stores a control program executed by the control unit 10. The memory unit 30 may store a program, a parameter, a waveform, and the like used in the sound source unit 80. The speaker 60 amplifies and outputs a sound signal output from the control unit 10 or the sound source unit 80, thereby generating a sound corresponding to the sound signal.

The key operation measurement unit 75 measures each operation of the plurality of keys 70, and outputs measurement data indicating the measurement result. The measurement data includes key number data Kn and key position data Ks (m). The key number data Kn is information (for example, a key number) for identifying the operated key 70 among the plurality of keys 70. The key position data Ks (m) is information indicating a position when the key 70 is pressed, that is, a pressing amount. In this example, m is any of 1, 2, 3, and 4 and is information output when the pressing amount of the key 70 reaches a predetermined amount.

The key 70 is rotatable in a range (pressing range) from a rest position (pressing amount is 0 mm) to an end position (pressing amount is 10 mm). Ks (1) is output when the pressing amount is 2.7 mm. Ks (2) is output when the pressing amount is 4.5 mm. Ks (3) is output when the pressing amount is 6.3 mm. Ks (4) is output when the pressing amount is 8.1 mm. As described above, in this example, four sensors are arranged for one key 70 in order to detect the pressing amount of the key 70. The pressing amount at which Ks (m) is output is an example, and can be set to various values. Kn and Ks (m) are output in association with each other, so that the operated key 70 and the operation content of the key 70 are specified by the measurement data output from the key operation measurement unit 75.

The sound source unit 80 includes a DSP (Digital Signal Processor), generates a sound signal based on the measurement data input from the key operation measurement unit 75, and outputs the sound signal to the speaker 60. The sound signal generated by the sound source unit 80 is obtained every time the key 70 is operated. A plurality of sound signals obtained corresponding to a plurality of key pressings are combined and output from the sound source unit 80. A configuration of the sound source unit 80 will be described in detail.

### [Configuration of Sound Source Unit]

FIG. 2 is a block diagram showing a functional configuration of a sound source unit according to an embodiment. The DSP in the sound source unit 80 implements a conversion unit 81, a model set memory unit 83, a signal generation unit 85, a waveform data memory unit 87, and a sound signal output unit 89 by executing a predetermined program stored in the memory unit 30. At least part of each of these functions may be implemented by hardware.

The conversion unit 81 acquires the key number data Kn and the key position data Ks (m) sequentially output from the key operation measurement unit 75, and converts the key number data Kn and the key position data Ks (m) into control data CD in the format used in the signal generation unit 85. In this example, the control data CD is data defining the sound generation content according to MIDI format and includes note-on and note-off corresponding to the key number data Kn. The note-on, which is data for instructing sound generation (sound generation instruction data), is associated with a velocity related to the volume of sound generation. The conversion unit 81 controls the sound content of the sound signal generated by the signal generation unit 85 by using the control-data CD. That is, the conversion unit 81 functions as a sound generation control device.

Here, a pattern of the key position data Ks (m) when the key 70 is pressed will be described.

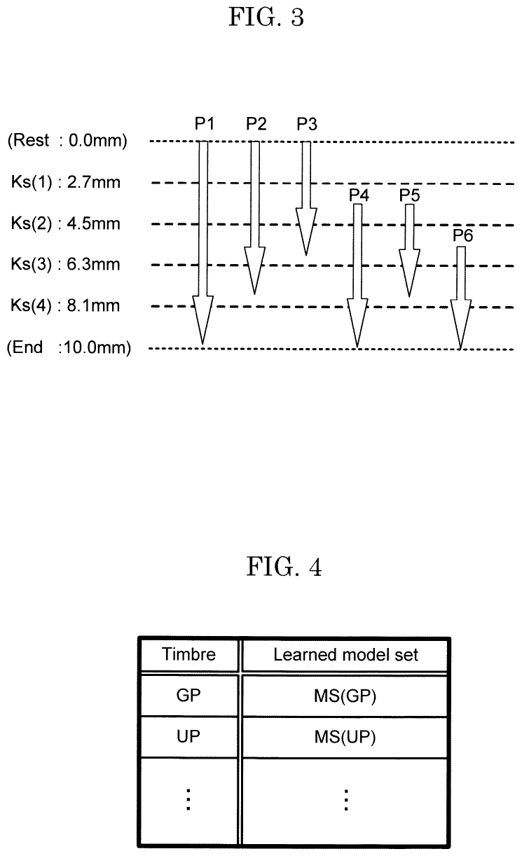

FIG. 3 is a diagram showing a positional relationship of a key position sensor and a key depression detection pattern according to an embodiment. According to a typical key depression, the key 70 is pressed from the rest position (Rest) to the end position (End), as shown in a pattern P1 of FIG. 3. However, the actual key depression is not limited to the pattern P1, and various patterns exist. In order to measure the moving speed of the key 70, it is necessary to detect the pressing amount of the key 70 at least at two positions. Assuming that this moving velocity is measured, in the case where the pressing amount of the key 70 at four positions can be detected as in this example, the key depression detection pattern (hereinafter, sometimes referred to as a key depression pattern) includes patterns P2 to P6 in addition to the pattern P1.

For example, even if a finger leaves the key 70 before the key is pressed to the end position, in an actual acoustic piano, an action mechanism may continue to operate inertially, and the hammer may strike a string. Such a key depression pattern corresponds to the patterns P2, P3, and P5 shown in FIG. 3. There is also a playing method in which the key 70 is depressed again before returning to the rest position after being depressed. Such a key depression pattern corresponds to the patterns P4, P5, and P6 shown in FIG. 3.

In the case where a time difference from a previous key release operation to a current key pressing operation is equal to or longer than a predetermined time, the hammer returns to its original position, and the key pressing operation is started in a state where the movement of the hammer is stopped. On the other hand, in the case where the time difference from the previous key release operation to the current key pressing operation is smaller than the predetermined time, the key pressing operation is started before the hammer returns to its original position and before the movement of the hammer is stabilized (before the inertial movement is stopped). Such a case corresponds to a performance operation by consecutively hitting the key 70. Since the state of the hammer when the key depression is started is different between the case of single hitting and the case of consecutive hitting, the operation of the hammer after the key depression is also different. In the following explanation, the case where the key depression pattern is single hitting and the pattern P1 may be represented as a single-hit pattern P1, and the case of the consecutive hitting and the pattern P4 may be represented as a consecutive-hit pattern P4.

The description will be continued by returning to FIG. 2. The conversion unit 81 acquires action data from the learned model to which the key position data Ks (m) is input, and outputs the control data CD based on the action data. The learned model is a model having a neural network generated by causing a computer such as an external server to perform machine learning on the corresponding relationship between time-series data and the action data of a keypress amount in an acoustic piano. The learned model generated in this way is provided to the keyboard instrument 1. In this example, the learned model is a model using LSTM (Long Short Term Memory). The learned model may be a model using another model, for example, a model using RNN (Recurrent Neural Network), or a model using GRU (Gated Recurrent Unit). The other model may include HMM (HIDDEN MARKOV MODEL) or SVM (SUPPORT VECTOR MACHINE). In the case of a model such as SVM, the neural network part and the model may be interchanged and used.

The action data is data related to the action of the action mechanism on the sounding body accompanied by a keypress, including the information (Kon Time) related to the sound generation timing, and the information (Velocity) related to the sound volume of the sound generation. In the case where the action data is associated with an acoustic piano, the sounding body is a string, and the action mechanism corresponds to a hammer striking the string. In this case, the action data can be said to be data related to striking by a hammer in the acoustic piano. In this example, the action data includes a striking timing (Kon Time) with reference to a timing corresponding to the key operation, and a hammer velocity (Velocity) at the time of striking due to the key operation. In the following description, a keyboard instrument such as a piano used in generating the learned model may be referred to as a model keyboard instrument.

The learned model used in the conversion unit 81 is provided corresponding to the key depression pattern when the key 70 is pressed. In this example, the conversion unit 81 uses a learned model corresponding to each of the 12 types of key depression patterns including single hitting and consecutive hitting for each of the patterns P1 to P6. The detailed configuration implemented by the conversion unit 81 will be described later.

The model set memory unit 83 stores a combination of 12 types of learned models (hereinafter referred to as a learned model set) used in the conversion unit 81 in association with a timbre. This corresponding relationship is defined by a model set table.

FIG. 4 is a diagram showing a model set table according to an embodiment. As shown in FIG. 4, the model set table defines a corresponding relationship between the timbre and the learned model set. In the example shown in FIG. 4, the timbre “GP (grand piano)” and the learned model set “MS (GP)” are associated with each other.

The learned model set “MS (GP)” includes the 12 types of learned models described above. As described above, the 12 types of learned models are learned models corresponding to the key operation from the patterns P1 to P6 for each of the single hitting and the consecutive hitting patterns. Each learned model is a model generated by machine learning the relationship between the striking timing and the hammer velocity with respect to the operation mode of the key in the grand piano. In the actual grand piano, the operation mode of the key and the striking timing have a correlation, and the operation mode of the key and the hammer velocity have a correlation. Teacher data for learning used for machine learning includes time-series data of the keypress amount and the resulting striking timing and hammer velocity. Such teacher data is generated using a result measured in advance by attaching a sensor to the actual grand piano.

The timbre “UP (upright piano)” corresponds to the learned model set “MS (UP).” The 12 types of learned models included in the learned model set “MS (UP)” are models generated by machine learning the relationship between the striking timing and hammer velocity with respect to the operation of the key in the upright piano. In this case, although the grand piano and the upright piano each indicate one type of timbre, a different timbre may be set depending on the type of apparatus. In that case, in the machine learning when the learned model is generated, the teacher data obtained from the result measured using the piano corresponding to each timbre is used.

The conversion unit 81 acquires time-series data of the plurality of key position data Ks (m) to be input, and inputs the time-series data to an input layer of the learned model. The time-series data includes information on the combined pattern of the key position data Ks (m) and the timing at which the key position data Ks (m) is acquired (which may be the timing output from the key operation measurement unit 75). Since the time-series data indicates the pressing amount of the key 70 in time series, the time-series data can also be referred to as operation data indicating an operation of the key 70. The learned model to which the time-series data is input outputs action data including the striking timing and the hammer velocity to an output layer as a result of the calculation in an intermediate layer.

The description will be continued by returning to FIG. 2. The waveform data memory unit 87 stores a settable timbre, for example, waveform data corresponding to each of the grand piano and the upright piano. For example, the waveform data corresponding to the grand piano is waveform data obtained by sampling a sound of the grand piano (a sound generated by striking a string accompanied by a key depression).

The signal generation unit 85 generates and outputs a sound signal based on control data DC output from the conversion unit 81. In this case, a sound signal is generated using the waveform data corresponding to the set timbre among the waveform data stored in the waveform data memory unit 87.

The sound signal output unit 89 outputs the sound signal generated by the signal generation unit 85 to the outside of the sound source unit 80. In this example, sound data is output to the speaker 60 and heard by the user. Next, a detailed configuration of the conversion unit 81 will be described.

### [Configuration of Conversion Unit]

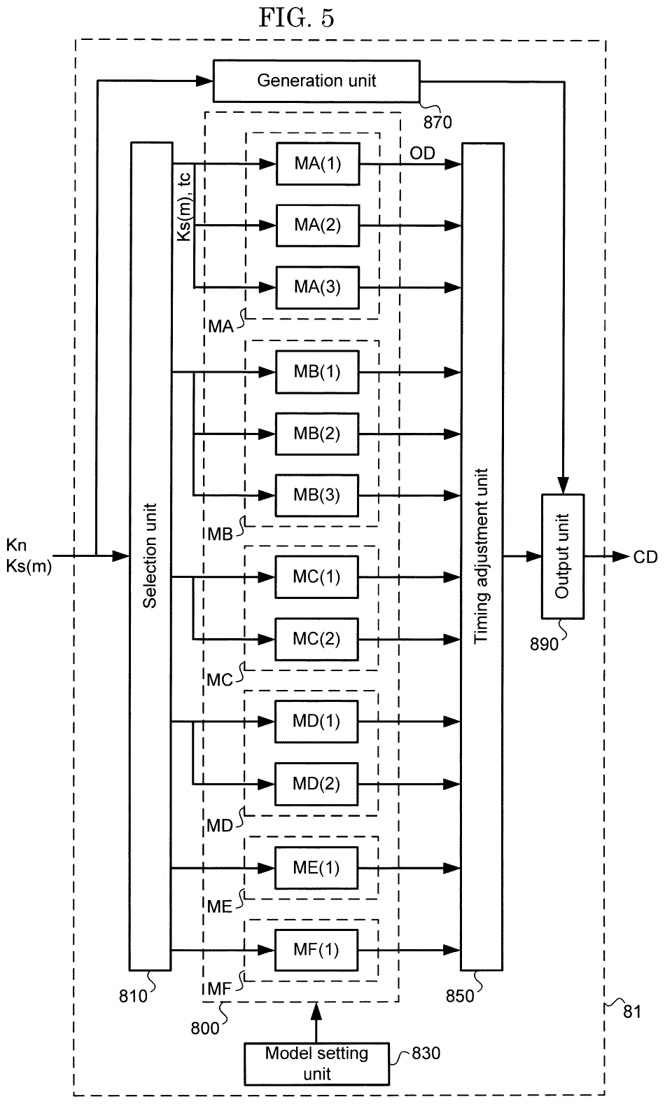

FIG. 5 is a block diagram showing a functional configuration of a conversion unit according to an embodiment. The conversion unit 81 includes a learned model set 800, a selection unit 810, a model setting unit 830, a timing adjustment unit 850, a generation unit 870, and an output unit 890. As described above, the learned model set 800 includes the learned model corresponding to each of the 12 types of key depression patterns. In this case, the learned models MA (MA (1), MA (2), MA (3)), MB (MB (1), MB (2), MB (3)), MC (MC (1), MC (2)), MD (MD (1), MD (2)), ME (ME (1)), and MF (MF (1)) are included.

When the user sets the timbre to be used for the keyboard instrument 1, the model setting unit 830 reads the learned model set corresponding to the timbre from the model set memory unit 83, and sets the learned model set as the learned model set 800. For example, when the timbre of the grand piano is set, the model setting unit 830 sets the learned model set “MS (GP)” as the learned model set 800.

The learned models MA (1), MA (2), and MA (3) correspond to the single-hit pattern P1, a single-hit pattern P2, and a single-hit pattern P3, respectively. The learned models MB (1), MB (2), and MB (3) correspond to a consecutive-hit pattern P1, a consecutive-hit pattern P2, and a consecutive-hit pattern P3, respectively. The learned model MC (1) and MC (2) correspond to a single-hit pattern P4 and a single-hit pattern P5, respectively. The learned models MD (1) and MD (2) correspond to the consecutive-hit pattern P4 and a consecutive-hit pattern P5, respectively. The learned model ME (1) corresponds to a single-hit pattern P6. The learned model MF (1) corresponds to a consecutive-hit pattern P6. As described above, the learned models MA, MC, and ME are models for single hitting (single-hit learned model), and the learned models MB, MD, and MF are models for consecutive hitting (consecutive-hit learned model) patterns. Next, each learned model will be described.

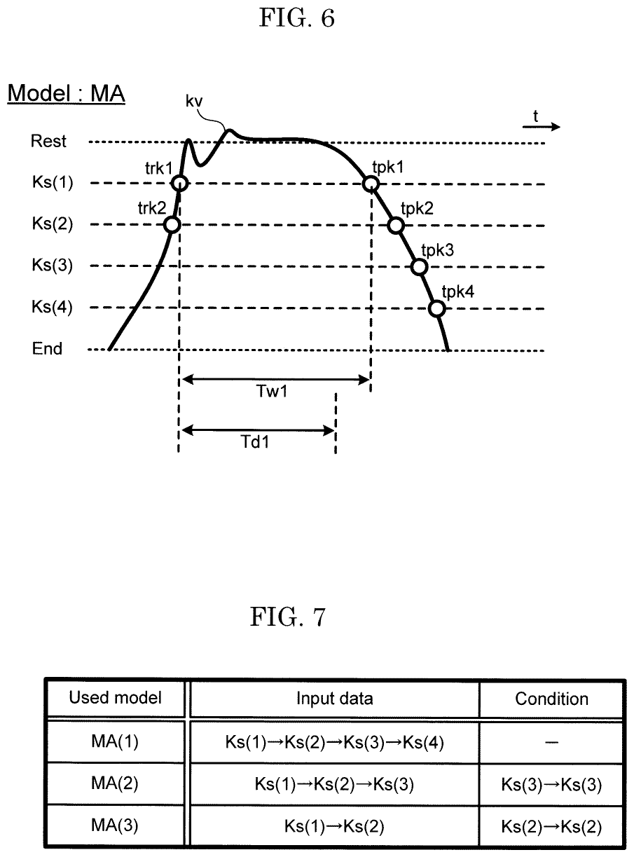

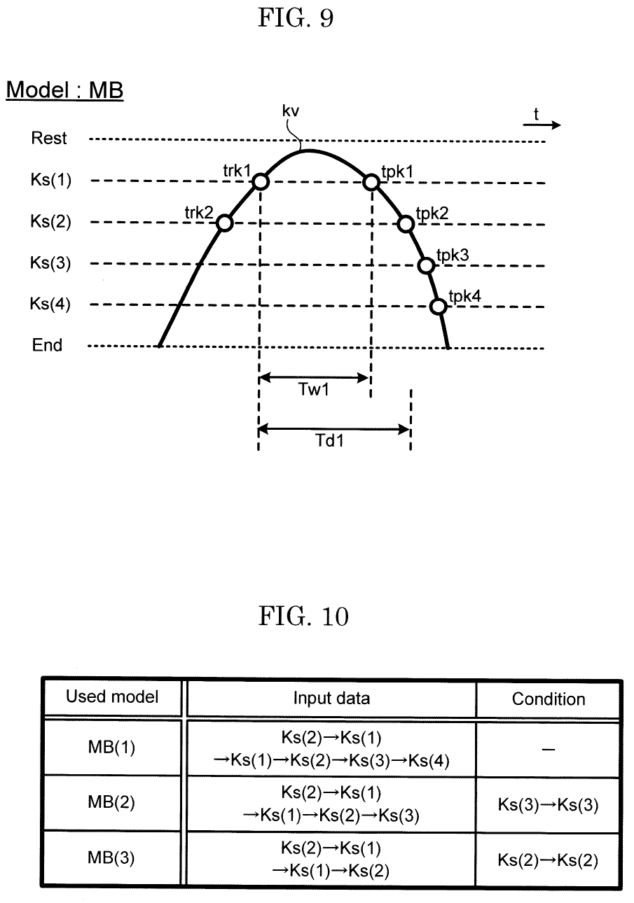

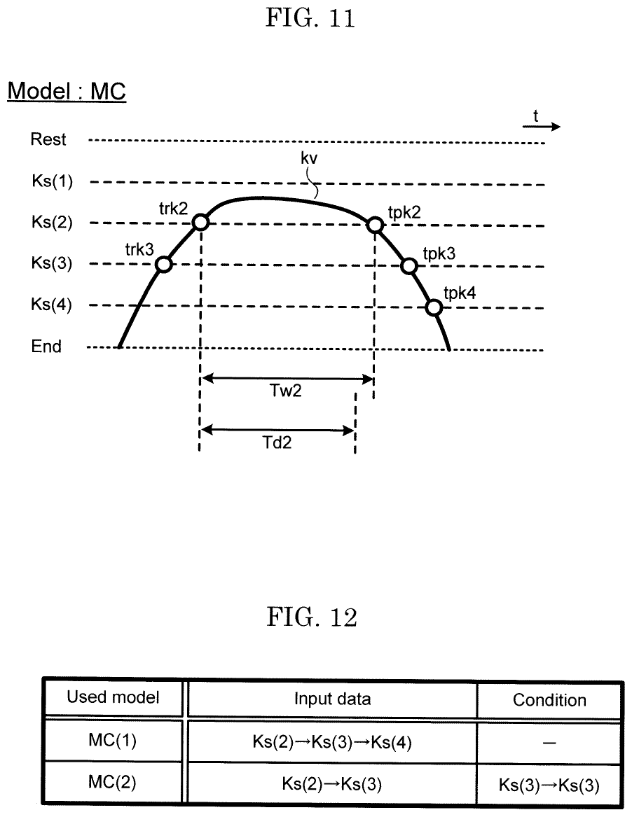

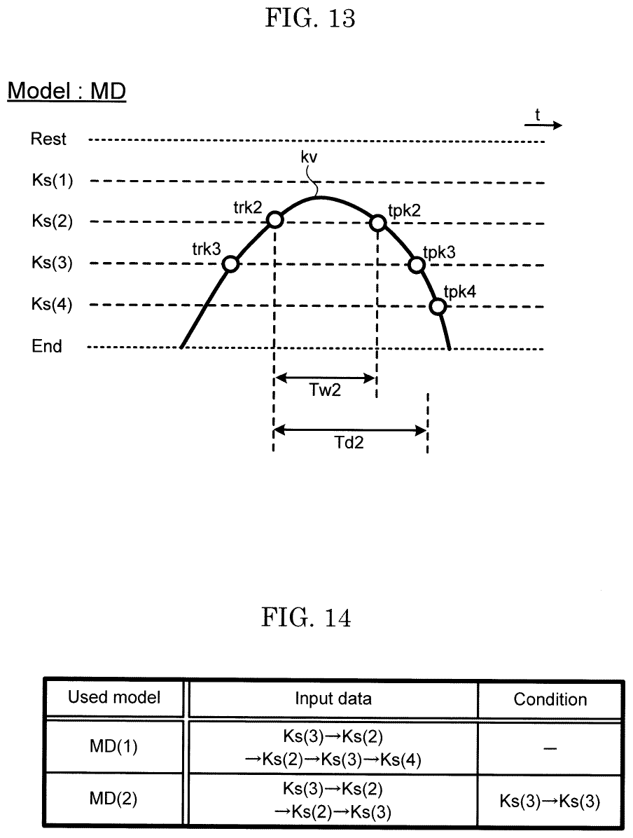

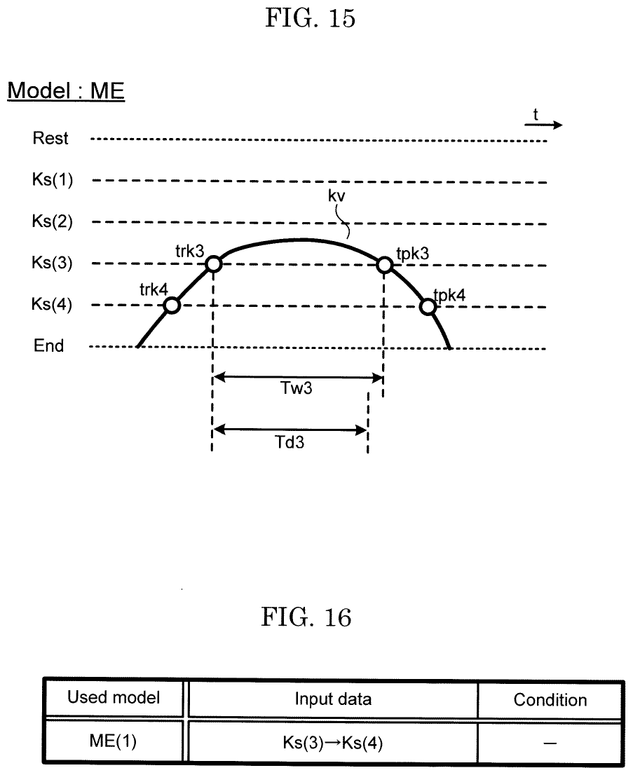

FIG. 6 is a diagram showing an example of a change in the key position corresponding to the learned model MA. FIG. 6 is a diagram showing a temporal change in a key position change kv and an acquisition timing of the key position data Ks (m). The horizontal axis indicates the time, and the vertical axis corresponds to the pressing amount of the key 70. In the direction of the vertical axis, Ks (1), Ks (2), Ks (3) and Ks (4) are evenly arranged between the rest position (Rest) and the end position (End). These are merely arranged evenly for convenience, and it is not necessary that the sensors are evenly arranged. In this example, a distance between adjacent Ks is 1.8 mm from Ks (1) to Ks (4). On the other hand, a distance between the rest position and Ks (1) is 2.7 mm and a distance between the end position and Ks (4) is 1.9 mm. The same applies to FIG. 9, FIG. 11, FIG. 13, FIG. 15 and FIG. 17 described later.

According to the key position change kv shown in FIG. 6, an example from the last key release to the next key depression is shown. According to the key position change kv, Ks (2) and Ks (1) are acquired in this order in the key release, and Ks (1), Ks (2), Ks (3), and Ks (4) are acquired in this order in the key depression. The acquisition times (acquisition timing) correspond to trk2, trk1, tpk1, tpk2, tpk3, and tpk4, respectively. Tw1 (tpk1−trk1), which is the time from Ks (1) at the time of key release to Ks (1) at the time of key depression, is used to determine whether the key depression corresponds to a single-hit or consecutive-hit. In the case where Ks (1) is acquired, if Ks (2) is acquired just before, it is specified that it is Ks (1) at the time of key release. In the case where Ks (1) is acquired, Ks (1) is acquired just before and Ks (2) is acquired immediately after, it is specified that it is Ks (1) at the time of key depression. As shown in FIG. 6, Tw1 is equal to or more than a preset Td1. The key depression in this case is interpreted as an operation after the hammer returns to its original position by the key release. Therefore, the key depression pattern of the key position change kv shown in FIG. 6 corresponds to the single-hit pattern P1. The same applies to the case where Ks (1) is acquired at the time of key depression and Ks (1) is not detected within the past Td1.

In the case where the key 70 is not depressed to the end position at the time of key depression and the finger leaves the key 70 in the middle of key depression, the following two examples are assumed depending on the timing at which the finger leaves. As a first example, Ks (4) may not be acquired after Ks (3) is acquired at the time of key depression, and Ks (3) may be acquired again. The first example corresponds to the single-hit pattern P2. As a second example, Ks (3) may not be acquired after Ks (2) is acquired at the time of key depression, and Ks (2) may be acquired again. The second embodiment corresponds to the single-hit pattern P3.

FIG. 7 is a diagram showing a model used among the learned model MA. The conversion unit 81 uses the learned model MA in the case of the single-hit pattern P1 to the single-hit pattern P3, that is, in the case of starting from acquiring Ks (1) at the time of single hitting and key depression. In the case where Ks (3) is not acquired after Ks (2) is acquired and Ks (2) is acquired again (condition Ks (2)→Ks (2)), that is, in the case of the single-hit pattern P3, the learning model MA (3) is used by the conversion unit 81. In the case where Ks (4) is not acquired after Ks (3) is acquired, and Ks (3) is acquired again (conditional Ks (3)→Ks (3)), that is, in the case of the single-hit pattern P2, the learned model MA (2) is used by the conversion unit 81. In the case where the data is acquired up to Ks (4), that is, in the case of the single-hit pattern P1, the learning model MA (1) is used by the conversion unit 81.

Here, the learned model MA (1) will be further described. As described above, the learned model is generated by machine learning the corresponding relationship (teacher data) between the time-series data for learning and the action data for learning related to a time series of the keypress amount in the model keyboard instrument. When the time-series data is input to the input layer of the learned model, calculation processing is executed in the intermediate layer in which the parameter is determined by the machine learning, and the action data is output from the output layer of the learned model. Hereinafter, the time-series data may be referred to as input data, and the action data may be referred to as output data.

The time series data is determined corresponding to the key depression pattern. For example, the learned model MA (1) corresponds to the single-hit pattern P1. Therefore, the time-series data is data related to acquisition times of Ks (1), Ks (2), Ks (3), and Ks (4) corresponding to the pattern P1. In this example, the acquisition time is converted into a value based on the time of the key position data (here, Ks (1)) acquired at the beginning of the key depression pattern.

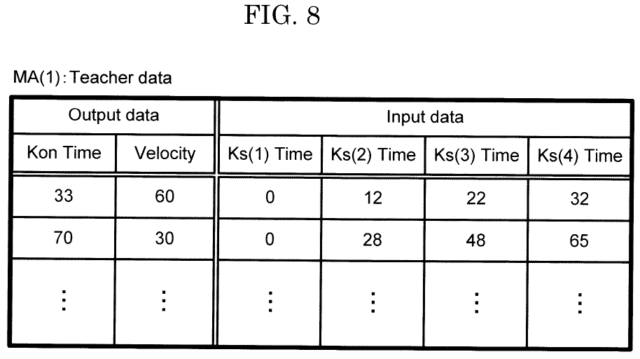

FIG. 8 is a diagram showing an example of the teacher data used when the learned model MA (1) is generated. The teacher data is data indicating a corresponding relationship between time-series data (input data) and action data (output data) used in machine learning. The teacher data corresponding to the learned model MA (1) includes the input data and the output data shown in FIG. 8.

The input data corresponds to the single-hit pattern P1 corresponding to the learned model MA (1). In other words, the input data shows the acquisition times “Ks (1) Time,” “Ks (2) Time,” “Ks (3) Time,” and “Ks (4) Time” corresponding to Ks (1), Ks (2), Ks (3), and Ks (4), respectively. The acquisition times correspond to “tpk1”, “tpk2”, “tpk3”, and “tpk4” in the example shown in FIG. 6. In this case, the acquisition time of Ks (1) is used as a reference. Therefore, “Ks (1) Time”, “Ks (2) Time”, “Ks (3) Time”, and “Ks (4) Time” are represented as “0”, “tpk2−tpk1”, “tpk3−tpk1”, and “tpk4−tpk1”. For example, the unit of the acquisition time is the number of counts of a timer that operates according to an internal clock.

The output data indicates the sound generation timing “Kon Time” of the sounding body and the velocity “Velocity” of the action mechanism (for example, a part acting on the sounding body) when acting on the sounding body, when the key of the model keyboard instrument is pressed as indicated by the input data. The “Kon Time” is represented in this example with reference to the reference time of the input data, that is, the time of the key position data (here, Ks (1)) acquired at the beginning of the key depression pattern. The “Velocity” is represented by 128 steps from “0” to “127”, and corresponds to the sound volume of the sound generation as described above. If the model keyboard instrument is an acoustic piano, the sound generation timing corresponds to the timing when the hammer strikes, and the velocity of the action mechanism corresponds to the velocity of the hammer. In this example, the key depression pattern, the striking timing, and the hammer velocity are actually measured using the acoustic piano which is the model keyboard instrument.

The learned model MA (1) is generated by performing machine learning using the teacher data exemplified in FIG. 8. Although not exemplified, the teacher data used in generating the other learned models may be input data according to the key depression pattern corresponding to the learned model. For example, since the learned model MA (3) corresponds to the single-hit pattern P3, the input data in the teacher data may be the acquisition times “Ks (1) Time” and “Ks (2) Time” of Ks (1) and Ks (2), respectively.

Since machine learning is performed in such a manner, the time-series data input to the learned models MA (1), MA (2), and MA (3) is determined as shown in FIG. 7. That is, in the case of the learned model MA (2) corresponding to the single-hit pattern P2, the time-series data (input data) is data (“Ks (1) Time”, “Ks (2) Time”, and “Ks (3) Time”) related to the acquisition times of Ks (1), Ks (2), and Ks (3). In the case of the learned model MA (3) corresponding to the single-hit pattern P3, the time-series data (input data) is data (“Ks (1) Time” and “Ks (2) Time”) related to the acquisition times of Ks (1) and Ks (2). The action data (output data) includes “Kon Time” and “Velocity” regardless of the learned model. Details of the method for generating the learned model will be described later.

FIG. 9 is a diagram showing an example of a change in a key position corresponding to a learned model MB. According to the key position change kv, Ks (2) and Ks (1) are acquired in this order in the key release, and Ks (1), Ks (2), Ks (3), and Ks (4) are acquired in this order in the key depression. The acquisition times correspond to trk2, trk1, tpk1, tpk2, tpk3, and tpk4, respectively. This is the same as the example shown in FIG. 6. On the other hand, the time Tw1 (tpk1−trk1) from Ks (1) at the time of key release to Ks (1) at the time of key depression is smaller than the time Td1. This key depression is interpreted as an operation before the hammer returns to its original position by the key release. Therefore, the key depression pattern of the key position change kv shown in FIG. 9 corresponds to the consecutive-hit pattern P1.

In the case where the key 70 is not depressed to the end position at the time of key depression and the finger leaves the key 70 in the middle of key depression, the key depression pattern may correspond to the consecutive-hit pattern P2 and the consecutive-hit pattern P3 according to the timing at which the finger leaves as in the case of single hitting.

FIG. 10 is a diagram showing a model used among the learned models MB. In the case of the consecutive-hit pattern P1 to the consecutive-hit pattern P3, that is, in the case of starting from acquiring Ks (1) at the time of consecutive hitting and key depression, the conversion unit 81 utilizes the learned model MB. In the case where Ks (3) is not acquired after Ks (2) is acquired and Ks (2) is acquired again (condition Ks (2)→Ks (2)), that is, in the case of the consecutive-hit pattern P3, a learning model MB (3) is used by the conversion unit 81. In the case where Ks (4) is not acquired after Ks (3) is acquired, and Ks (3) is acquired again (condition Ks (3)→Ks (3)), that is, in the case of the consecutive-hit pattern P2, a learning model MB (2) is used by the conversion unit 81. In the case where the data is acquired up to Ks (4), that is, in the case of the consecutive-hit pattern P1, a learning model MB (1) is used by the conversion unit 81.

The learned model MA and the learned model MB are different by a single hit or consecutive hits, and the time series data input to these learned models are different. As shown in FIG. 10, the learned model MB (1) corresponds to the consecutive-hit pattern P1. Therefore, the time-series data includes data related to the acquisition times of Ks (1), Ks (2), Ks (3), and Ks (4) corresponding to the pattern P1, as well as data related to the acquisition times of Ks (2) and Ks (1) at the time of the previous key release. In such a case of consecutive hits, the acquisition time of Ks (2) and Ks (1) at the time of key release just before key depression is further used. That is, the time-series data in the case of single hitting includes the acquisition time of the time range related to the key depression, but the time-series data in the case of consecutive hitting further includes the acquisition time of the time range related to the key release. The acquisition time is converted into a value based on the time of the key position data (here, Ks (1) at the time of key depression) acquired at the beginning of the key depression pattern. The acquisition time of Ks (2) at the time of key release used first may be used as a reference.

The time-series data input to the learned model MB (1) is data related to the acquisition times of Ks (2) and Ks (1) at the time of key release, and Ks (1), Ks (2), Ks (3), and Ks (4) at the time of key depression. That is, the time-series data includes “Ks (2) Time”, “Ks (1) Time”, “Ks (1) Time”, “Ks (2) Time”, “Ks (3) Time”, and “Ks (4) Time”. The time-series data input to the learned model MB (2) is data related to the acquisition times of Ks (2) and Ks (1) at the time of key release, and Ks (1), Ks (2), and Ks (3) at the time of key depression. That is, the time-series data includes “Ks (2) Time”, “Ks (1) Time”, “Ks (1) Time”, “Ks (2) Time”, and “Ks (3) Time”. The time-series data input to the learned model MB (3) is data related to the acquisition times of Ks (2) and Ks (1) at the time of key release, and Ks (1) and Ks (2) at the time of key depression. That is, the time-series data includes “Ks (2) Time”, “Ks (1) Time”, “Ks (1) Time”, and “Ks (2) Time”. The action data (output data) includes “Kon Time” and “Velocity” regardless of any learned model.

For the teacher data used in generating the learned model MB, the input data part may correspond to the above-described time-series data, which is the same as the case of the learned model MA, and therefore explanation will be omitted.

FIG. 11 is a diagram showing an example of a change in the key position corresponding to the learned model MC. According to the key position change kv, Ks (3) and Ks (2) are acquired in this order in the key release, and Ks (2), Ks (3), and Ks (4) are acquired in this order in the key depression. The acquisition times correspond to trk3, trk2, tpk2, tpk3, and tpk4, respectively. Time Tw2 (tpk2−trk2) from Ks (2) at the time of key release to Ks (2) at the time of key depression is equal to or more than a preset time Td2. In this case, the key depression is interpreted as an operation in a state in which the movement of the hammer is stable (after the inertial movement is stopped). Therefore, the key depression pattern of the key position change kv shown in FIG. 11 corresponds to the single-hit pattern P4. The same applies when Ks (2) is acquired at the time of key depression and Ks (2) is not detected within the past Td2. The time Td2 and the above-described time Td1 may be the same or different.

In the case where the key 70 is not depressed to the end position at the time of key depression and the finger leaves the key 70 in the middle of key depression, the key depression pattern may correspond to the single-hit pattern P5 according to the timing at which the finger leaves.

FIG. 12 is a diagram showing a model used among the learned models MC. The conversion unit 81 utilizes the learned-model MC in the case of the single-hit pattern P4 or the single-hit pattern P5, that is, in the case of starting from acquiring Ks (2) at the time of single hitting and key depression. In the case where Ks (4) is not acquired after Ks (3) is acquired, and Ks (3) is acquired again (condition Ks (3)→Ks (3)), that is, in the case of the single-hit pattern P5, the learning model MC (2) is used by the conversion unit 81. In the case where the data is acquired up to Ks (4), that is, in the case of the single-hit pattern P4, the learning model MC (1) is used by the conversion unit 81.

As shown in FIG. 12, the learned model MC (1) corresponds to the single-hit pattern P4. Therefore, the time-series data includes data related to the acquisition times of Ks (2), Ks (3), and Ks (4) corresponding to the pattern P4. The acquisition time is converted into a value based on the time of the key position data (here, Ks (2)) acquired at the beginning of the key depression pattern.

The time-series data input to the learned model MC (1) is data related to the acquisition times of Ks (2), Ks (3), and Ks (4). That is, the time series data includes “Ks (2) Time”, “Ks (3) Time”, and “Ks (4) Time”. The time-series data input to the learned model MC (2) is data related to the acquisition time of Ks (2) and Ks (3). In other words, the time series data includes “Ks (2) Time” and “Ks (3) Time”. The action data (output data) includes “Kon Time” and “Velocity” regardless of any learned model.

For the teacher data used in generating the learned model MC, the input data part may correspond to the above-described time-series data, which is the same as the case of the learned model MA, and therefore explanation will be omitted.

FIG. 13 is a diagram showing an example of a change in the key position corresponding to the learned model MD. According to the key position change kv, Ks (3) and Ks (2) are acquired in this order in the key release, and Ks (2), Ks (3), and Ks (4) are acquired in this order in the key depression. The acquisition times correspond to trk3, trk2, tpk2, tpk3, and tpk4, respectively. The time Tw2 (tpk2−trk2) from Ks (2) at the time of key release to Ks (2) at the time of key depression is smaller than the preset time Td2. In this case, the key depression is interpreted to be an operation in a state before the movement of the hammer is stabilized (before the inertial movement is stopped). Therefore, the key depression pattern of the key position change kv shown in FIG. 13 corresponds to the consecutive-hit pattern P4.

In the case where the key 70 is not depressed to the end position at the time of key depression and the finger leaves the key 70 in the middle of key depression, the key depression pattern may correspond to the consecutive-hit pattern P5 according to the timing at which the finger leaves.

FIG. 14 is a diagram showing a model used among the learned models MD. In the case of the consecutive-hit pattern P4 or consecutive-hit pattern P5, that is, in the case of starting from acquiring Ks (2) at the time of consecutive hitting and key depression, the conversion unit 81 utilizes the learned model MD. In the case where Ks (4) is not acquired after Ks (3) is acquired, and Ks (3) is acquired again (condition Ks (3)→Ks (3)), that is, in the case of the consecutive-hit-pattern P5, the learned model MD (2) is used by the conversion unit 81. In the case where the data is acquired up to Ks (4), that is, in the case of the consecutive-hit pattern P4, the learning model MD (1) is used by the conversion unit 81.

The learned model MC and the learned model MD are different by a single hit or consecutive hits, and the time-series data input to these learned models are different. As shown in FIG. 14, the learned model MD (1) corresponds to the consecutive-hit pattern P4. Therefore, the time-series data includes data related to the acquisition times of Ks (2), Ks (3), and Ks (4) corresponding to the pattern P4, as well as data related to the acquisition times of Ks (3) and Ks (2) at the time of the previous key release. In this case of consecutive hitting, the point that the acquisition time of the two pieces of key position data at the time of key release just before the key depression is further used is the same as in the case of the learned model MB. The acquisition time is converted into a value based on the time of the key position data (here, Ks (2) at the time of key depression) acquired at the beginning of the key depression pattern. The acquisition time of Ks (2) at the time of key release used first may be used as a reference.

The time-series data input to the learned model MD (1) is data related to the acquisition time of Ks (3) and Ks (2) at the time of key depression, and Ks (2), Ks (3), and Ks (4) at the time of key release. That is, the time series data includes “Ks (3) Time”, “Ks (2) Time”, “Ks (2) Time”, “Ks (3) Time”, and “Ks (4) Time”. The time-series data input to the learned model MD (2) is data related to the acquisition times of Ks (3) and Ks (2) at the time of key release, and Ks (2) and Ks (3) at the time of key depression. That is, the time series data includes “Ks (3) Time”, “Ks (2) Time”, “Ks (2) Time”, and “Ks (3) Time”. The action data (output data) includes “Kon Time” and “Velocity” regardless of the learned model.

For the teacher data used when the learned model MD is generated, the input data part may correspond to the above-described time-series data, which is the same as the case of the learned model MA, and therefore explanation will be omitted.

FIG. 15 is a diagram showing an example of a change in the key position corresponding to the learned model ME. According to the key position change kv, Ks (4) and Ks (3) are acquired in this order in the key release, and Ks (3) and Ks (4) are acquired in this order in the key depression. The acquisition times correspond to trk4, trk3, tpk3, and tpk4, respectively. Time Tw3 (tpk3−trk3) from Ks (3) at the time of key release to Ks (3) at the time of key depression is equal to or more than a preset time Td3. In this case, the key depression is interpreted as an operation in a state in which the movement of the hammer is stable (after the inertial movement is stopped). Therefore, the key depression pattern of the key position change kv shown in FIG. 15 corresponds to the single-hit pattern P6. The same applies when Ks (3) is acquired at the time of key depression and Ks (3) is not detected within the past Td3. The time Td3 and the above-described times Td1 and Td2 may be the same or different.

FIG. 16 is a diagram showing a model used among the learned models ME. In the case of the single-hit pattern P6, that is, in the case of starting from acquiring Ks (3) at the time of single hitting and key depression, the conversion unit 81 utilizes the learned model ME (in this example, the learned model ME (1)). As shown in FIG. 16, the learned model ME (1) corresponds to the single-hit pattern P6. Therefore, the time-series data includes data related to the acquisition times of Ks (3) and Ks (4) corresponding to the pattern P6. The acquisition time is converted into a value based on the time of the key position data (here, Ks (3)) acquired at the beginning of the key depression pattern.

The time-series data input to the learned model ME (1) is data (“Ks (3) Time” and “Ks (4) Time”) related to the acquisition times of Ks (3) and Ks (4). The action data (output data) includes “Kon Time” and “Velocity.”

For the teacher data used in generating the learned model ME, the input data part may correspond to the above-described time-series data, which is the same as the case of the learned model MA, and therefore explanation will be omitted.

FIG. 17 is a diagram showing an example of a change in the key position corresponding to the learned model MF. According to the key position change kv, Ks (4) and Ks (3) are acquired in this order in the key release, and Ks (3) and Ks (4) are acquired in this order in the key depression. The acquisition times correspond to trk4, trk3, tpk3, and tpk4, respectively. The time Tw3 (tpk3−trk3) from Ks (3) at the time of key release to Ks (3) at the time of key depression is smaller than the preset time Td3. In this case, the key depression is interpreted to be an operation in a state before the movement of the hammer is stabilized (before the inertial movement is stopped). Therefore, the key depression pattern of the key position change kv shown in FIG. 17 corresponds to the consecutive-hit pattern P6.

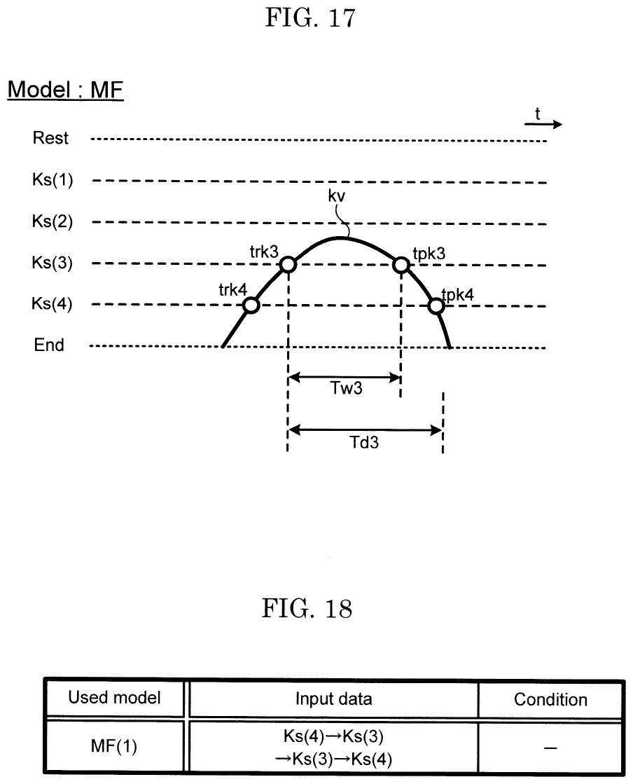

FIG. 18 is a diagram showing a model used among the learned models MF. The conversion unit 81 uses the learned model MF (in this case, the learned model MF (1)) in the case of the consecutive-hit pattern P6, that is, in the case of starting from acquiring Ks (3) at the time of consecutive hitting and key depression. The learned model ME and the learned model MF are different by a single hit or consecutive hits, and the time series data input to these learned models are different. As shown in FIG. 18, the learned model MF (1) corresponds to the consecutive-hit pattern P6. Therefore, the time-series data includes, in addition to the data related to the acquisition times of Ks (3) and Ks (4) corresponding to the pattern P6, the data related to the acquisition times of Ks (4) and Ks (3) at the time of the previous key release. In the case of consecutive hitting, further using the acquisition time of the two pieces of key position data at the time of releasing the key just before the key depression is the same as in the case of the learned models MB and MD. The acquisition time is converted into a value based on the time of the key position data (here, Ks (3) at the time of key depression) acquired at the beginning of the key depression pattern. The acquisition time of Ks (2) at the time of the key release used at the beginning may be used as a reference.

The time-series data input to the learned model MF (1) is data related to the acquisition times of Ks (4) and Ks (3) at the time of key release, and Ks (3) and Ks (4) at the time of key depression. That is, the time series data includes “Ks (4) Time”, “Ks (3) Time”, “Ks (3) Time”, and “Ks (4) Time”. The action data (output data) includes “Kon Time” and “Velocity.”

For the teacher data used in generating the learned model MF, the input data part may correspond to the above-described time-series data, which is the same as the case of the learned model MA, and therefore explanation will be omitted.

The description will be continued by returning to FIG. 5. The selection unit 810 acquires key number data Kn and key position data Ks (m) sequentially output from the key operation measurement unit 75. The selection unit 810 performs the processing described below separately for each pitch corresponding to the key number data Kn. The selection unit 810 selects one of the learned models MA, MB, MC, MD, ME, and MF based on the key position data Ks (m) and the acquired timing tc acquired sequentially, and associates and outputs Ks (m) and tc. As described above, one of the learned models MA, MB, MC, MD, ME, and MF is selected based on the order of acquiring Ks (m), and Tw1, Tw2, Tw3, and Tw4.

The learned model MA is selected in the case of starting from acquiring Ks (1) at the time of single hitting and key depression. For example, it is equal to the case where Ks (1) at the time of key depression is acquired and Ks (1) at the time of key release is not acquired within the previous Td1. In this case, the selection unit 810 outputs the acquired Ks (m) and tc to the learned models MA (1), MA (2), and MA (3). Subsequently, when Ks (m) is acquired, the selection unit 810 sequentially outputs Ks (m) and tc. The learned models MA (1), MA (2), and MA (3) receive Ks (m) and tc as time-series data and output action data OD as output data by calculations using them as input data. In the case where the learned model MA (3) receives Ks (3) at the time of key depression (in the case where it is determined that it is not the key depression pattern P3), calculation processing for outputting the action data OD is stopped. In the case where the learned model MA (2) receives Ks (4) at the time of key depression (in the case where it is determined that it is not the key depression pattern P2), calculation processing for outputting the action data OD is stopped.

The learned model MB is selected in the case of starting from acquiring Ks (1) at the time of consecutive hitting and key depression. For example, it is equal to the case where Ks (1) at the time of key depression is acquired and Ks (1) at the time of key release is acquired within the previous Td1. In this case, the selection unit 810 outputs the acquired Ks (m) and tc to the learned models MB (1), MB (2), and MB (3). Subsequently, when Ks (m) is acquired, the selection unit 810 sequentially outputs Ks (m) and tc. The learned models MB (1), MB (2), and MB (3) receive Ks (m) and tc as time-series data, and output the action data OD as output data by calculations using them as input data. In the case where the learned model MB (3) receives Ks (3) at the time of key depression (in the case where it is determined that it is not the key depression pattern P3), calculation processing for outputting the action data OD is stopped. In the case where the learning model MB (2) receives Ks (4) at the time of key depression (in the case where it is determined that it is not the key depression pattern P2), calculation processing for outputting the action data OD is stopped.

The learned model MC is selected in the case of starting from acquiring Ks (2) at the time of single hitting and key depression. For example, it is equal to the case where Ks (2) at the time of key depression is acquired and Ks (2) at the time of key release is not acquired within the previous Td2. In this case, the selection unit 810 outputs the acquired Ks (m) and tc to the learned models MC (1) and MC (2). Subsequently, when Ks (m) is acquired, the selection unit 810 sequentially outputs Ks (m) and tc. The learned models MC (1) and MC (2) receive Ks (m) and tc as time-series data, and output the action data OD as output data by calculations using them as input data. In the case where the learned model MC (2) receives Ks (4) at the time of key depression (in the case where it is determined that it is not the key depression pattern P5), calculation processing for outputting the action data OD is stopped.

The learned model MD is selected in the case of starting from acquiring Ks (2) at the time of consecutive hitting and key depression. For example, it is equal to the case where Ks (2) at the time of key depression is acquired and Ks (2) at the time of key release is acquired within the previous Td2. The selection unit 810 outputs the acquired Ks (m) and tc to the learned models MD (1) and MD (2). Subsequently, when Ks (m) is acquired, the selection unit 810 sequentially outputs Ks (m) and tc. The learned models MD (1) and MD (2) receive Ks (m) and to as time-series data, and output the action data OD as output data by calculations using them as input data. In the case where the learned model MD (2) receives Ks (4) at the time of key depression (in the case where it is determined that it is not the key depression pattern P5), calculation processing for outputting the action data OD is stopped.

The learned model ME is selected in the case of starting from acquiring Ks (3) at the time of single hitting and key depression. For example, it is equal to the case where Ks (3) at the time of key depression is acquired and Ks (3) at the time of key release is not acquired within the previous Td3. The selection unit 810 outputs the acquired Ks (m) and tc to the learned model ME (1). Subsequently, when Ks (m) is acquired, the selection unit 810 sequentially outputs Ks (m) and tc. The learned model ME (1) receives Ks (m) and tc as time-series data, and outputs the action data OD as output data by calculations using them as input data.

The learned model MF is selected in the case of starting from acquiring Ks (3) at the time of consecutive hitting and key depression. For example, it is equal to the case where Ks (3) at the time of key depression is acquired and Ks (3) at the time of key release is acquired within the previous Td3. The selection unit 810 outputs the acquired Ks (m) and tc to the learned model MF (1). Subsequently, when Ks (m) is acquired, the selection unit 810 sequentially outputs Ks (m) and tc. The learned model MF (1) receives Ks (m) and tc as time-series data, and outputs the action data OD as output data by calculations using them as input data.

Upon receiving the action data OD from any one of the learned models among the learned model set 800, the timing adjustment unit 850 outputs “Velocity” at a timing corresponding to “Kon Time” included in the action data OD. The timing corresponding to “Kon Time” indicates, for example, a time obtained by adding “Kon Time” to the reference time used in the learned model in which the action data OD is output. This timing may be corrected by a predetermined time in consideration of the influence of the subsequent processing or the like. For example, in the case of considering processing delays, this timing may be set to a time before a predetermined time.

When the timing adjustment unit 850 outputs “Velocity”, if there is a learned model in the learned model set 800 during calculation processing, the calculation processing is stopped. For example, it is assumed that the timing adjustment unit 850 acquires the action-data OD from the learned model MA (2). In this case, since the learned model MA (1) is waiting for the input of Ks (4) and tc, calculation processing of the learned model MA (1) is stopped and the input to the input layer is initialized.

The generation unit 870 acquires the key number data Kn and the key position data Ks (m) sequentially output from the key operation measurement unit 75. Upon detecting the key release according to the sequentially acquired pattern of Ks (m), the generation unit 870 generates information indicating the note-off of the pitch corresponding to Kn and outputs the information to the output unit 890. Upon detecting the key depression according to the sequentially acquired pattern of Ks (m), the generation unit 870 generates information indicating the note-on of the pitch corresponding to Kn and outputs the information to the output unit 890.

Upon receiving information indicating the note-off from the generation unit 870, the generation unit 890 outputs the control data CD indicating the note-off. Upon receiving the information indicating the note-on from the generation unit 870, the generation unit 890 waits until it receives “Velocity” from the timing adjustment unit 850. Upon receiving “Velocity,” the output unit 890 outputs the control data CD indicating note-on with “Velocity” as the velocity value.

The control data CD output from the conversion unit 81 in this way is used in the signal generation unit 85 to generate a sound signal. Next, a method for controlling sound generation implemented by the processing in the conversion unit 81 will be described.

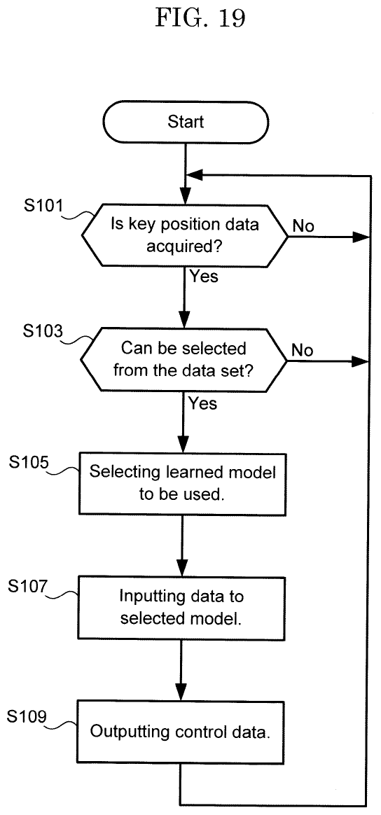

FIG. 19 is a flowchart showing a method for controlling sound generation according to an embodiment. When the keyboard instrument 1 is activated, the conversion unit 81 executes processing for the method for controlling sound generation. This processing is executed corresponding to each key (each pitch). The conversion unit 81 waits until the key position data Ks (m) is acquired (step S101; No). When the key position data Ks (m) is acquired (step S101; Yes), the conversion unit 81 determines whether the learned model can be selected by a combination (data set) of the acquired key position data Ks (m) (step S103). The learned model to be selected is the model to which the selection unit 810 should output Ks (m) and tc.

In the case where the learned model cannot be selected from the data set (step S103; No), the conversion unit 81 waits until the key position data Ks (m) is acquired again (step S101; No). In the case where the learned model can be selected from the data set (step S103; Yes), the conversion unit 81 selects the learned model to be used (step S105). The conversion unit 81 inputs the key position data Ks (m) and tc to the selected learned model (step S107).

The conversion unit 81 generates the control data CD using “Kon Time” and “Velocity” included in the action data OD obtained from the selected learned model and outputs it to the signal generation unit 85 (step S109), and waits until the key position data Ks (m) is acquired again (step S101; No). The above is the description of the conversion unit 81.

The keyboard instrument 1 according to the above-described embodiment uses the learned model to acquire the sound generation timing and velocity from the time-series data of the key position data Ks (m) corresponding to the operation of the key 70, and generates a sound signal using these parameters. The learned model is generated using the teacher data that reproduces the model keyboard instrument. Therefore, even in the keyboard instrument 1 such as an electronic keyboard apparatus having a sound generation mechanism completely different from the model keyboard instrument, the relationship between the performance and the sound generation mode can be made close to that of the model keyboard instrument.

Next, a system for generating the learned model will be described.

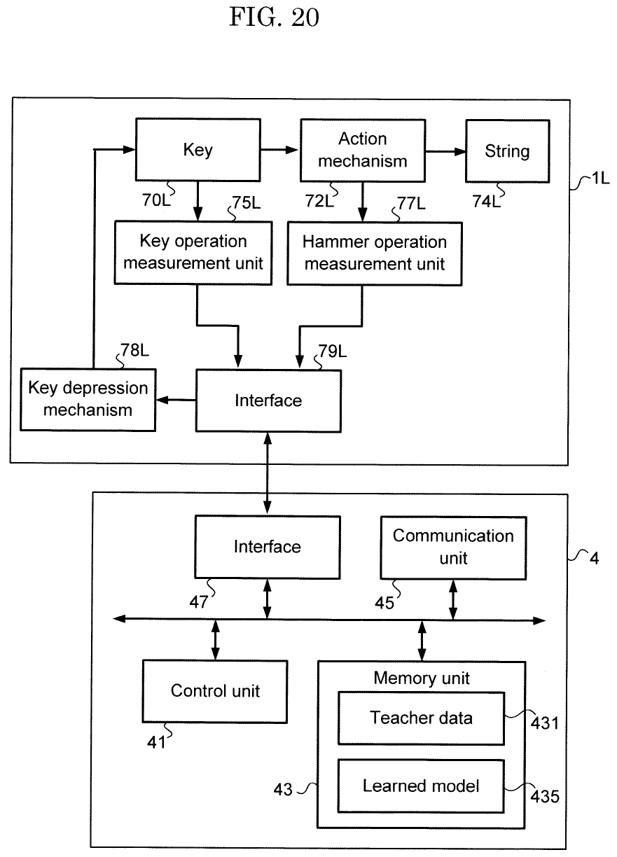

FIG. 20 is a diagram showing a configuration of a model generation system according to an embodiment. The model generation system shown in FIG. 20 includes a model keyboard instrument 1L and a model generation device 4. The model keyboard instrument 1L includes a key 70L, an action mechanism 72L, a string 74L, a key operation measurement unit 75L, a hammer operation measurement unit 77L, a key depression mechanism 78L, and an interface 79L. The keys 70L, the action mechanism 72L, and the string 74L correspond to the key, the action mechanism, and the string in the grand piano, respectively. Therefore, the action mechanism 72L includes a hammer for striking the string.

Similar to the key operation measurement unit 75 described above, the key operation measurement unit 75L measures an operation of the key 70L and outputs key measurement data indicating the measurement result. If it is not the case of generating a learned model corresponding to a plurality of keys of different pitches, it is sufficient to be configured so that the key measurement data is output corresponding to a specific key 70L. The key measurement data includes the key position data Ks (m). The key number data Kn may not be included in the key measurement data. The key position data Ks (m) is the same as that included in the measurement data output from the key operation measurement unit 75 described above. That is, Ks (1) to Ks (4) are output according to the pressing amount of the key 70L.

The hammer operation measurement unit 77L measures the timing at which the hammer in the action mechanism 72L hits the string 74L and the velocity at which the hammer hits the string 74L, and outputs hammer measurement data indicating the measurement result.

The key depression mechanism 78L includes a structure, for example, a solenoid, for depressing the key 70L. The key depression mechanism 78L is controlled to depress the key 70L in various ways. For example, the operation of the key depression mechanism 78L is controlled by a control signal transmitted from the model generation device 4.

The interface 79L is connected to the model generation device 4 by wire or wirelessly. The interface 79L outputs the control signal received from the model generation device 4 to the key depression mechanism 78L. The interface 79L transmits the key measurement data output from the key operation measurement unit 75L and the hammer measurement data output from the hammer operation measurement unit 77L to the model generation device 4.

The model generation device 4 includes a control unit 41, a memory unit 43, a communication unit 45, and an interface 47.

The control unit 41 includes a calculation processing circuit, such as a CPU, and a memory device, such as RAM and ROM. The control unit 41 executes a control program using the CPU to realize a teacher data generation function and a learned model generation function in the model generation device 4. The teacher data generation function is a function for generating teacher data and recording the teacher data in the memory unit 43. The learned model generation function is a function for generating a learned model and recording the learned model in the memory unit 43. The control unit 41 generates a control signal for controlling the key depression mechanism 78L.

The memory unit 43 is a memory device such as a non-volatile memory or a hard disk. The memory unit 43 stores a control program executed by the control unit 41. The memory unit 43 stores the generated teacher data 431 and the generated learned model 435. The teacher data 431 includes input data and output data as in the teacher data shown in FIG. 8. The learned model 435 corresponds to the learned model included in the learned model set.

The communication unit 45 transmits the learned model 435 and the like by communicating with the external device. The interface 47 is connected to the model keyboard instrument 1L by wire or wirelessly. The interface 47 transmits the control signal to the model generation device 4. The interface 47 receives the key measurement data and the hammer measurement data from the model generation device 4.

A method executed by the teacher data generation function and the learned model generation function implemented by the control unit 41 will be described.

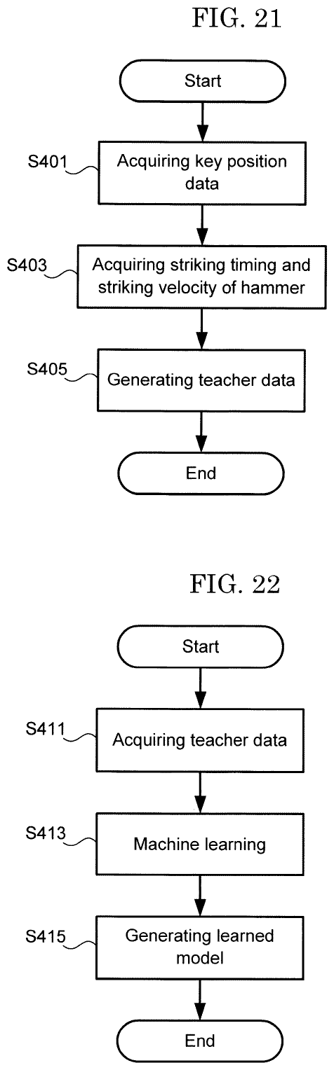

FIG. 21 is a flowchart showing a method for generating teacher data according to an embodiment. When an instruction for starting the teacher data is input by the user, the control unit 41 sets various depression modes, and sequentially outputs control signals corresponding to the depression modes to the model keyboard instrument 1L. The method for generating the teacher data shown in FIG. 21 is executed each time the control signal is output to the model keyboard instrument 1L. The number of control signals required to generate the learned model are generated and sequentially output to the model keyboard instrument 1L.

The control unit 41 acquires the key measurement data and the hammer measurement data output from the model keyboard instrument 1L by the key depression mechanism 78L operating the key 70L according to the control signal. As a result, the control unit 41 acquires the key position data Ks (m) (step S401), and acquires the striking timing and the striking velocity of the hammer (step S403). The control unit 41 generates the teacher data 431 using the key position data Ks (m) as the input data and the striking timing and the striking velocity as the output data, records the generated teacher data 431 in the memory unit 43 (step S405), and ends the process.

In this way, a set of the input data and the output data corresponding to the number of the generated control signals is recorded in the memory unit 43 as the teacher data 431. At this time, the teacher data 431 is classified into the 12 types of key depression patterns described above.

FIG. 22 is a flowchart showing a method for generating a learned model according to an embodiment. The method for generating the learned model shown in FIG. 22 is executed when an instruction for generating the learned model is input by the user. The control unit 41 acquires the teacher data 431 from the memory unit 43 (step S411). The control unit 41 executes machine learning using the teacher data 431 classified for each key depression pattern (step S413), generates the learned model 435 corresponding to each key depression pattern, records the generated learned model 435 in the memory unit 43 (step S415), and ends the process. The above-described learned model set is generated by the learned model corresponding to the 12 types of key depression patterns. The above explanation is a description of a system for generating a learned model.

Here, the model generation device 4 may further generate a rule table that defines a corresponding relationship between the input data and the output data by using the learned model set. For example, the rule table is stored in the memory unit 43. The rule table may be used instead of the learned model set used in the conversion unit 81 of the keyboard instrument 1.

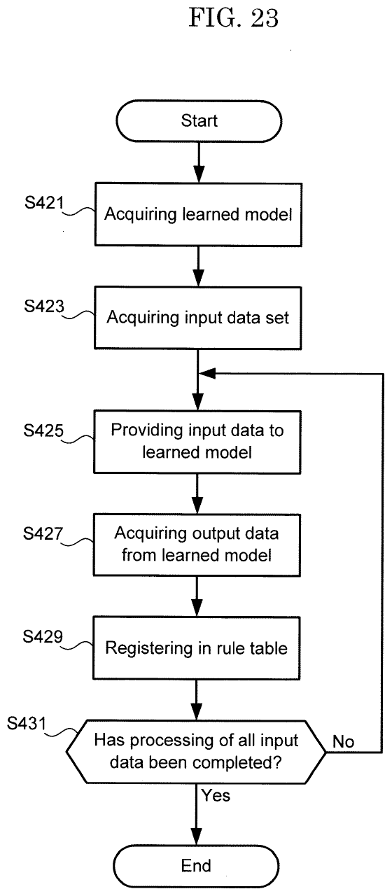

FIG. 23 is a flowchart showing a method for registering a rule table according to an embodiment. The method for registering the rule table shown in FIG. 23 is executed when an instruction for generating the rule table is input by the user. The control unit 41 acquires the learned model 435 (step S421). The control unit 41 acquires an input data set corresponding to the key depression pattern corresponding to the acquired learned model 435 (step S423). The input data set includes a plurality of input data corresponding mutually to the same key depression pattern. The plurality of input data are different from each other in at least one value of key position data Ks (m) corresponding to the same key depression pattern. In other words, the plurality of input data indicate various modes of key pressing operations in the same key depression pattern.

The control unit 41 provides one input data among the plurality of input data to the learned model 435 (step S425), and acquires output data from the learned model 435 (step S427). The control unit 41 registers the input data and the output data in the rule table in association with each other (step S429). In the case where the processing of all the input data included in the input data set has not been completed (step S431; No), the control unit 41 returns to the step S425 to continue the processing of the remaining input data. On the other hand, in the case where the processing of all the input data included in the input data set is completed (S431; Yes in steps), the control unit 41 ends the processing in the method for registering the rule table. The rule table generated in this way will be described. The rule table is generated for each key depression pattern.

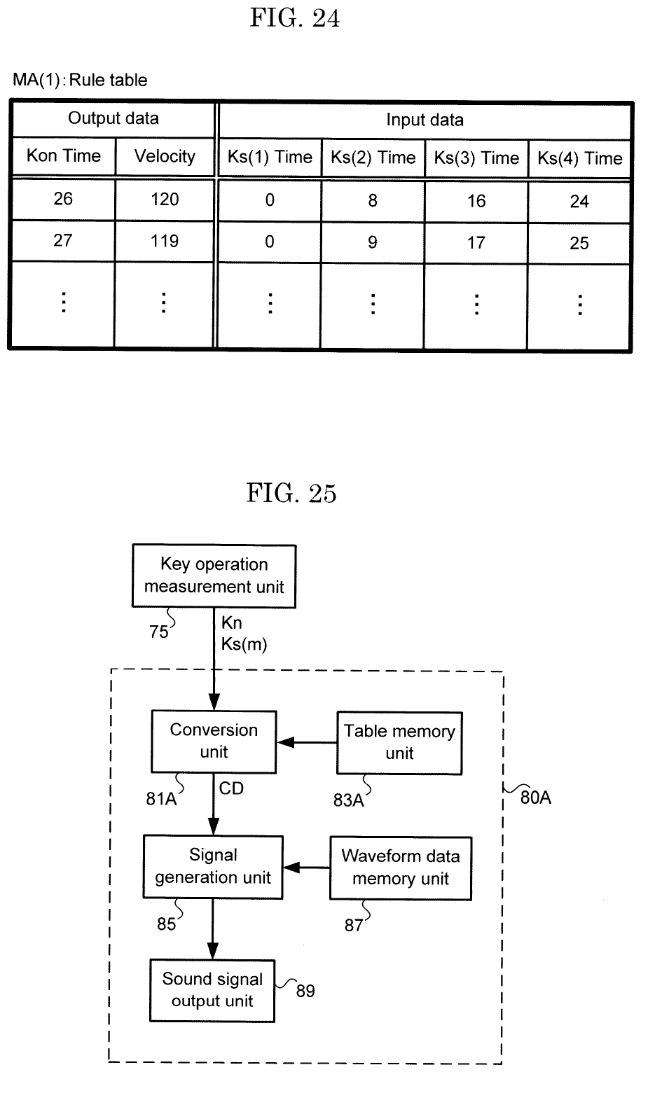

FIG. 24 is a diagram showing a rule table according to an embodiment. The rule table shown in FIG. 24 is an example of a rule table in which the key depression pattern is used in place of the learned model MA (1) corresponding to the single-hit pattern P1. The input data registered in the rule table corresponds to a plurality of input data included in the input data set acquired in the above-described step S423. The output data corresponding to the rule table corresponds to the output data acquired in the step S427 corresponding to the respective input data.

As described above, the rule table defines output data for various types of key pressing operations (input data) in the corresponding key depression pattern. In the case of the single-hit pattern P1, for example, 100 types of values are set for Ks (2) to Ks (4) based on Ks (1), respectively, in the input data. As a result, 10⁶ patterns (1M patterns) are registered in the rule table. In the case of the consecutive-hit pattern P1, when the same concept is applied, Ks (1) at the time of key release and Ks (1) to Ks (4) at the time of key depression are present based on Ks (2) at the time of key release, so that 10¹⁰ patterns (10 G patterns) are required.

On the other hand, the consecutive-hit pattern P1 is not required to be more accurate than the single-hit pattern P1. Therefore, the number of possible values of each of Ks (m) in the consecutive-hit pattern may be reduced as compared with the single-hit pattern. For example, if Ks (1) at the time of key release and Ks (1) at the time of key depression are set to 20 values, and Ks (2) to Ks (4) at the time of key depression are set to 50 values, 5×10⁷ patterns (50M patterns) is sufficient. The operation mode at the time of key depression has a larger influence on the output data than the operation mode at the time of key release. Therefore, as shown in this example, the number of possible values of each of Ks (m) is preferably greater after the key depression has started than before the key depression has started.

Next, an example in which the rule table is used in place of the learned model in the conversion unit 81 of the keyboard instrument 1 will be described.

FIG. 25 is a block diagram showing a functional configuration of a sound source unit according to an embodiment. A sound source unit 80A shown in FIG. 25 includes a conversion unit 81A, a table memory unit 83A, the signal generation unit 85, the waveform data memory unit 87, and the sound signal output unit 89. The signal generation unit 85, the waveform data memory unit 87, and the sound signal output unit 89 have the same functions as those of the sound source unit 80 described above. The table memory unit 83A stores a rule table set. The rule table set includes a rule table corresponding to each key depression pattern.

The conversion unit 81A is similar to the configuration of the conversion unit 81 shown in FIG. 5, but the rule table is used in place of the learned models corresponding to each key depression pattern in the learned model set 800. Therefore, the model setting unit 830 is implemented as a function of setting the rule table. The conversion unit 81A has a function of obtaining the output data from the input data using the set rule table.

A calculation amount for obtaining the output data from the input data using the rule table is smaller than a calculation amount for obtaining the output data from the input data using the learned model. Therefore, the calculation processing capability of DSP used for the sound source unit 80A can be lowered by using the sound source unit 80A using the conversion unit 81A for the keyboard instrument 1.

### [Modifications]

The present disclosure is not limited to the above-described embodiments, and includes various other modifications. For example, the above-described embodiments have been described in detail for the purpose of illustrating the present disclosure in an easy-to-understand manner, and are not necessarily limited to those embodiments having all the described configurations. It is possible to add, delete, or replace a part of the configuration of one embodiment with another configuration. Some modifications will be described below.
(1) The model set memory unit 83 stores the learned model set in association with the timbre. The learned model set may be stored such that different sets are applied depending on the pitch to which the key 70 corresponds. Different learned model sets may be applied in each of all the keys 70, or different learned model sets may be arranged in each of a plurality of sound ranges. That is, different learned model sets among the keys 70 may be applied in the case where the first key is operated and in the case where the second key having a pitch different from that of the first key is operated.

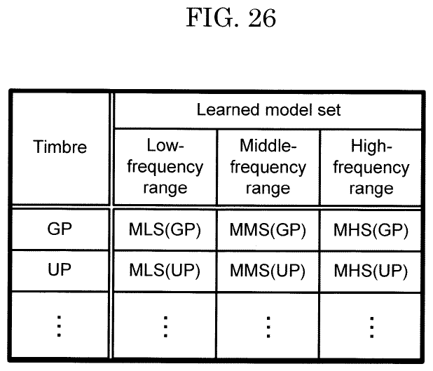

FIG. 26 is a diagram showing a model set table according to a modification. In the example of the model set table shown in FIG. 26, there are learned model sets corresponding to each of the plurality of sound ranges (a low-frequency range, a middle-frequency range, and a high-frequency range). For example, in the case where the timbre is “GP,” the learned model set includes a learned model set MLS (GP) applied to the low-frequency range, a learned model set MMS (GP) applied to the middle-frequency range, and a learned model set MHS (GP) applied to the high-frequency range. The key 70 belonging to each of the low-frequency range, middle-frequency range, and high-frequency range may be set in advance.

Regarding the learned model sets of each sound range, the teacher data used to generate each of the learned model sets are different. That is, the teacher data is data obtained by operating keys corresponding to each sound range.

In this way, the learned model included in the learned model set corresponding to the sound range to which the key 70 belongs can be used. That is, the keyboard instrument 1 can generate the sound signal by using the learned model obtained from the operation of the key 70 due to the difference in pitch, by using the action data closer to the model keyboard instrument.
(2) The action data OD includes “Kon Time” and “Velocity,” but the action data OD may include only one of these. In the case where the action data OD does not include “Velocity,” the generation unit 870 may generate information corresponding to “Velocity” based on the key position data Ks (m). For example, a velocity of the key 70 may be measured based on an acquisition time difference between the two Ks (m), and information corresponding to “Velocity” may be generated according to the velocity. On the other hand, in the case where the action data OD does not include “Kon Time,” the generation unit 870 may generate information corresponding to “Kon Time” based on the key position data Ks (m). For example, information corresponding to “Kon Time” may be generated according to the timing at which Ks (3) is acquired.
(3) Although an acoustic piano such as a grand piano and an upright piano having a structure in which an action mechanism operates and a hammer strikes a string is exemplified as the model keyboard instrument, the model keyboard instrument may be a keyboard instrument having a structure other than a structure in which a hammer strikes a string. For example, the model keyboard instrument may be a clavichord having an action mechanism for picking a string as a sounding body, or a celesta having an action mechanism for hitting a metal plate as a sounding body. As described above, the model keyboard instrument may include the action mechanism for causing the sounding body to generate a sound by operating a key.
(4) The keyboard instrument 1 may be applied in combination with an acoustic piano. For example, the keyboard instrument 1 is a keyboard instrument in which the function of an electronic keyboard apparatus is added to an acoustic piano. Such a keyboard instrument has the key in an acoustic piano and the key 70 in the keyboard instrument 1 as common configurations. Further, in the case where the keyboard instrument is operated as an acoustic piano, the keyboard instrument may have a configuration which stops a function of generating a sound signal as the electronic keyboard apparatus. In the case where the keyboard instrument is operated as an electronic keyboard apparatus, the keyboard instrument may have a configuration to operate so that striking by a hammer is prevented.

In the case of a keyboard instrument having such a configuration, an acoustic piano combined with the keyboard instrument 1 may be applied as a model keyboard instrument. In this way, the user can play with the same feeling, both when the keyboard instrument is operated as an acoustic piano and when the keyboard instrument is operated as an electronic keyboard apparatus. Further, the above-described model generation system may be combined with the keyboard instrument 1 so that the learned model can be generated in the keyboard instrument.
(5) The conversion unit 81 is not limited to outputting the control data CD to the signal generation unit 85 but may also output to an interface for providing the control data CD to the external device.
(6) The conversion unit 81 uses the learned model MA (1) in the case of acquiring Ks (1), Ks (2), Ks (3), and Ks (4) in this order as in the single-hit pattern P1. The conversion unit 81 uses the learned-model MA (2) in the case of acquiring Ks (1), Ks (2), and Ks (3) in this order as in the single-hit pattern P2. As described above, the learned model MA (2) stops calculation processing when Ks (4) is acquired.

In the case of the single-hit pattern P2 and the single-hit pattern P3, it is unlikely that “Kon Time” is calculated as the time prior to Ks (4) is acquired. On the other hand, it is also conceivable that the learned model MA (2) outputs the action data OD before Ks (4) is acquired. In such cases, if Ks (4) is not acquired even if the time corresponding to the “Kon Time” included in the action data OD is approached, calculation processing of the learned model MA (1) may be stopped.
(7) The conversion unit 81 may convert part of the acquired key position data Ks (m) into the control data CD. In this case, the key position data Ks (m) used as the input data in the learned model may be defined so that the key position data Ks (m) used for each key depression pattern or for each timbre may be defined differently. In the case where the key position data Ks (m) used in this way is different, the number of sensors capable of measuring the pressing amount of the key 70 may be larger, and not only the case where a sensor capable of measuring the pressing amount as a discrete value, but also a sensor capable of measuring the pressing amount as a consecutive value may be used.
(8) The information used as the input data in the learned model may further include the velocity of the key. For example, the velocity of the key may be calculated using the time difference of tc corresponding to the two key position data Ks (m) and the difference of the keypress amount, or may be obtained by a sensor that measures the velocity. In this case, a velocity of a key for learning is also used when the learned model is generated.
(9) The input data used for the teacher data and the input data to the learned model are not limited to the above-described time-series data as long as it is the operation data related to the time series of the keypress amount. For example, the velocity of the key calculated from the time series of the keypress amount may be used as the operation data. In the operation data in this case, position information regarding the position of the key corresponding to the velocity of the key is associated with the velocity of the key.

For example, the velocity of the key is calculated using the difference between the time difference of tc and the pressing amount corresponding to the two key position data Ks (m). This velocity may be an actual velocity or may be converted to be represented by 128 steps from “0” to “127”, similar to the Velocity described above. The two key position data Ks (m) used to calculate the velocity may correspond to positions adjacent to each other, or may correspond to positions not adjacent to each other.

For example, a velocity (referred to as Vs (1, 2)) calculated from the timing of Ks (1) (referred to as tc (1)) and the timing of Ks (2) (referred to as tc (2)) is expressed as Vs (1,2)=(4.5−2.7)/(tc (2)−tc (1)). Position information corresponding to Vs (1, 2) corresponds to a combination of the key position data used in the operation, that is, the information indicating Ks (1) and Ks (2).

For example, a velocity (referred to as Vs (1, 3)) calculated from the timing tc (1) of Ks (1) at the time of key depression and the timing (referred to as tc (3)) of Ks (3) is expressed as Vs (1, 3)=(6.3−2.7)/(tc (3)−tc (1)). Position information corresponding to Vs (1, 3) corresponds to a combination of the key position data used in the operation, that is, the information indicating Ks (1) and Ks (3).

At least two combinations of the following combinations of positions are used as the velocity of the key included in the operation data. The velocities obtained from the combination of positions are Vs (1, 2), Vs (1, 3), Vs (1, 4), Vs (2, 3), Vs (2, 4), and Vs (3, 4). In the case where the learned models are distinguished by the key depression pattern, the combination of positions that can be taken by the key depression pattern to be applied is different. For example, in the case of the key depression pattern that does not include Ks (1), the velocities obtained from the combination of positions are Vs (2, 3), Vs (2, 4), and Vs (3, 4). Although this example is shown as an example of the velocity at the time of key depression, in the case of considering the velocity at the time of key release assuming consecutive hits, Vs (2, 1) or the like may be added to the velocities obtained from the combination of positions.

In the case where the operation data in the modification (9) is used, the hammer velocity correlates with the velocity of the key and position information. Therefore, the action data includes information (Velocity) related to the sound volume of the sound generation, and does not include information (Kon Time) related to the sound generation timing. If information related to tc is further added to the operation data, since the striking timing is also correlated, information (Kon Time) related to the sound generation timing can be added in the action data.

The above is the description of the modifications.

As described above, according to an embodiment of the present disclosure, a method for controlling sound is provided includes; acquiring key position data corresponding to a keypress amount; inputting operation data obtained by the key position data and an acquisition timing of the key position data to a learned model that has learned a corresponding relationship between operation data configured to be used as learning data related to a time series of a keypress amount and action data configured to be used as learning data related to an action of an action mechanism on a sounding body accompanied with a keypress; and outputting sound generation instruction data configured to generate a sound signal in a signal generation unit based on action data output from the learned model.

The action data may include a striking velocity by a hammer.

The action data may include a timing of striking by a hammer.

The key position data may be acquired corresponding to a keypress amount at a plurality of predetermined positions within a pressing range of the key.

Acquiring the key position data may include acquiring first key position data corresponding to a first key and acquiring second key position data corresponding to a second key. Inputting the key position data to the learned model may include inputting operation data related to the first key position data to a first learned model that has learned a corresponding relationship between operation data configured to be used as learning data related to a time series of a keypress amount of a first key and action data configured to be used as learning data corresponding to the first key, and inputting operation data related to the second key position data to a second learned model that has learned a corresponding relationship between operation data configured to be used as learning data related to a time series of a keypress amount of the second key and action data configured to be used as learning data corresponding to the second key.

Inputting the operation data to the learned model may include: inputting operation data related to the key position data to a single-hit learned model that has learned a corresponding relationship between operation data configured to be used as learning data related to a time series of a keypress amount and including a time range in the key depression, and the action data configured to be used as learning data in the case where a time difference between a key depression corresponding to the key position data and key release just before the key depression is equal to or longer than a predetermined time; and inputting operation data related to the key position data to a consecutive-hit learned model that has learned a corresponding relationship between operation data configured to be used as learning data related to a time series of a keypress amount of a key configured to be used as learning data and including a time range in the key release just before the key depression and the key depression, and the action data configured to be used as learning data in the case where the time difference is smaller than the predetermined time.

The operation data configured to be used as learning data may include time-series data of the keypress amount. The operation data input to the learned model may include the key position data and the acquisition timing.

The operation data configured to be used as learning data may include a velocity of a key. Operation data input to the learned model may include the velocity of the key calculated from the key position data and the acquisition timing.

According to an embodiment of the present disclosure, the method for controlling sound generation may be provided as a program for causing a computer to execute the method for controlling sound generation, or may be provided as a sound generation control device for executing a method for controlling sound generation, or may be provided as an electronic keyboard apparatus including a sound generation control device.

According to the present disclosure, a relationship between a performance and a sound generation mode in an electronic keyboard apparatus can be made close to a relationship in a model keyboard instrument.

What is claimed is:

1. A method for controlling sound comprising:
acquiring key position data corresponding to a keypress amount;
inputting operation data obtained based on the key position data and an acquisition timing of the key position data to a learned model that has learned a corresponding relationship between
operation data configured to be used as learning data related to a time series of a keypress amount and
action data configured to be used as learning data related to an action of an action mechanism on a sounding body accompanied with a keypress; and
outputting sound generation instruction data configured to generate a sound signal in a signal generation unit based on action data output from the learned model.

2. The method for controlling sound according to claim 1, wherein
the action data includes a velocity of striking by a hammer.

3. The method for controlling sound according to claim 1, wherein
the action data includes a timing of striking by a hammer.

4. The method for controlling sound according to claim 1, wherein
the key position data is acquired corresponding to a keypress amount at a plurality of predetermined positions within a pressing range of the key.

5. The method for controlling sound according to claim 1, wherein
acquiring the key position data includes acquiring first key position data corresponding to a first key and acquiring second key position data corresponding to a second key,
inputting the key position data to the learned model includes:
inputting operation data related to the first key position data to a first learned model that has learned a corresponding relationship between
operation data configured to be used as learning data related to a time series of a keypress amount of a first key and
action data configured to be used as learning data corresponding to the first key; and
inputting operation data related to the second key position data to a second learned model that has learned a corresponding relationship between
operation data configured to be used as learning data related to a time series of a keypress amount of the second key and
action data configured to be used as learning data corresponding to the second key.

6. The method for controlling sound according to claim 1, wherein
inputting the operation data to the learned model includes:
inputting operation data related to the key position data to a single-hit learned model that has learned a corresponding relationship between
operation data configured to be used as learning data related to a time series of a keypress amount and including a time range in the key depression, and
the action data configured to be used as learning data in the case where a time difference between a key depression corresponding to the key position data and a key release just before the key depression is equal to or longer than a predetermined time; and
inputting operation data related to the key position data to a consecutive-hit learned model that has learned a corresponding relationship between
operation data configured to be used as learning data related to a time series of a keypress amount of a key configured to be used as learning data and including a time range in the key release just before the key depression and the key depression, and
the action data configured to be used as learning data in the case where the time difference is smaller than the predetermined time.

7. The method for controlling sound according to claim 1, wherein
the operation data configured to be used as learning data includes time-series data of the keypress amount, and
operation data input to the learned model includes the key position data and the acquisition timing.

8. The method for controlling sound according to claim 1, wherein
the operation data configured to be used as learning data includes a velocity of a key, and
operation data input to the learned model includes the velocity of the key calculated from the key position data and the acquisition timing.

9. A sound control apparatus comprising:
a memory storing a program; and
a processor executing the program,
wherein
in the case where the processor executes the program, the processor
acquires sequentially key position data corresponding to a keypress amount;
inputs operation data obtained based on the key position data and an acquisition timing of the key position data to a learned model that has learned a corresponding relationship between
operation data configured to be used as learning data related to a time series of a keypress amount and
action data configured to be used as learning data related to an action of an action mechanism on a sounding body accompanied with a keypress; and
outputs sound generation instruction data configured to generate a sound signal in a signal generation unit based on action data output from the learned model.

10. The sound control apparatus according to claim 9, wherein
the action data includes a velocity of striking by a hammer.

11. The sound control apparatus according to claim 9, wherein
the action data includes a timing of striking by a hammer.

12. The sound control apparatus according to claim 9, wherein
the key position data is acquired corresponding to a pressing amount at a plurality of predetermined positions within a pressing range of the key.

13. The sound control apparatus according to claim 9, wherein
acquiring the key position data includes acquiring first key position data corresponding to a first key and acquiring second key position data corresponding to a second key,
inputting the key position data to the learned model includes:
inputting operation data related to the first key position data to a first learned model that has learned a corresponding relationship between
operation data configured to be used as learning data related to a time series of a keypress amount of a first key and
action data configured to be used as learning data corresponding to the first key; and
inputting operation data related to the second key position data to a second learned model that has learned a corresponding relationship between
operation data configured to be used as learning data related to a time series of a keypress amount of the second key and
action data configured to be used as learning data corresponding to the second key.

14. The sound control apparatus according to claim 9, wherein
inputting the operation data to the learned model includes:
inputting operation data related to the key position data to a single-hit learned model that has learned a corresponding relationship between
operation data configured to be used as learning data related to a time series of a keypress amount and including a time range in the key depression, and
the action data configured to be used as learning data in the case where a time difference between a key depression corresponding to the key position data and a key release just before the key depression is equal to or longer than a predetermined time; and
inputting operation data related to the key position data to a consecutive-hit learned model that has learned a corresponding relationship between
operation data configured to be used as learning data related to a time series of a keypress amount of a key configured to be used as learning data and including a time range in the key release just before the key depression and the key depression, and
the action data configured to be used as learning data in the case where the time difference is smaller than the predetermined time.

15. The sound control apparatus according to claim 9, wherein
the operation data configured to be used as learning data includes time-series data of a keypress amount of the key, and
operation data input to the learned model includes the key position data and the acquisition timing.

16. The sound control apparatus according to claim 9, wherein
the operation data configured to be used as learning data includes a velocity of a key, and
operation data input to the learned model includes the velocity of the key calculated from the key position data and the acquisition timing.

17. An electronic keyboard apparatus comprising:
the sound control apparatus according to claim 9; and
the key.

18. The electronic keyboard apparatus according to claim 17, further comprising the signal generation unit configured to generate a sound signal according to the sound generation instruction data.

19. An electronic keyboard apparatus comprising:
a key;
a key operation measurement unit configured to output key position data corresponding to a keypress amount of the key;
a sound control apparatus configured to generate sound generation instruction data configured to generate a sound signal based on action data obtained by inputting operation data obtained based on the key position data and an output timing of the key position data to a learned model that has learned a corresponding relationship between
operation data configured to be used as learning data related to a time series of a keypress of the key amount and
action data configured to be used as learning data related to an action of an action mechanism on a sounding body accompanied with a keypress of the key.

20. The electric keyboard apparatus according to claim 19, wherein
the action data includes a velocity of striking by a hammer and a timing of striking by a hammer.
